(19) United States
(12) Patent Application Publication
(10) Pub. No.: US 2025/0055059 A1
(43) Pub. Date: Feb. 13, 2025

(54) Method and Apparatus for Embedded Heating of Battery Cell Holders

(71) Applicant: Textron Aviation Inc., Wichita, KS (US)

(72) Inventors: Russell Allan Sharp, Wichita, KS (US); Brandon Stuart Henderson, Wichita, KS (US)

(21) Appl. No.: 18/797,121

(22) Filed: Aug. 7, 2024

Related U.S. Application Data
(60) Provisional application No. 63/518,621, filed on Aug. 10, 2023.

(51) Int. Cl. H01M 10/637; B64D 47/00; H01M 10/42; H01M 10/615; H01M 10/625; H01M 10/643; H01M 10/653; H01M 50/291

(52) U.S. Cl. CPC H01M 10/637; B64D 47/00; H01M 10/425; H01M 10/615; H01M 10/625; H01M 10/643; H01M 10/653; H01M 50/291; H01M 2220/20

(57) ABSTRACT

A heated battery cell holder includes an upper cell holder having a plurality of holders each configured for securing an upper portion of one of a plurality of battery cells, respectively. A lower cell holder includes a plurality of holders each configured for securing a lower portion of one of the battery cells, respectively. An upper heating element is embedded in the upper cell holder for heating the upper portion of each of the battery cells, and a lower heating element is embedded in the lower cell holder for heating the lower portion of each of the battery cells.

### CROSS-REFERENCE TO RELATED APPLICATIONS

This application claims the benefit of U.S. Provisional Application No. 63/518,621 entitled “Method and Apparatus for Embedded Heating of Battery Cells Holders” and filed on Aug. 10, 2023, which is herein incorporated by reference in its entirety.

### BACKGROUND

### 1. Field

Embodiments of the invention relate generally to a method and apparatus for heating a battery, and more specifically to a method and apparatus for a heating element embedded in a cell holder and/or electrical cell conductor to transfer heat to battery cells.

### 2. Related Art

Previous methods of heating battery cells using integrated heaters within the cells have been attempted. U.S. Pat. No. 9,627,723 to Wang et al. describes a battery system with an integrated resistive heater utilizing resistive sheets to heat the cells. U.S. Pat. No. 9,882,197 to Wang et al. describes a battery system also with an integrated resistive heater wherein the resistive sheets may be used to hold “jelly roll assemblies” (e.g., battery assemblies). U.S. Pat. No. 10,186,887 to Wang et al. describes a battery system with an integrated resistive heater with high resistance and low resistance terminal connections to the batteries. U.S. Pat. No. 9,755,284 to Nubbe describes a battery system with an integrated resistive heater with heating elements of Nubbe interleaved between the battery cells. The heating element of Nubbe is a resistive wire. U.S. Patent Application Publication No. 2022/0271352 to Al-Hallaj et al. describes a battery system with an integrated resistive heater that holds the battery cells in a matrix. The matrix can be used to heat the cells.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the invention will be apparent from the following detailed description of the embodiments and the accompanying drawing figures.

In certain embodiments, a heated battery cell holder includes: an upper cell holder having a plurality of holders each configured for securing an upper portion of one of a plurality of battery cells, respectively; a lower cell holder having a plurality of holders each configured for securing a lower portion of one of the battery cells, respectively; an upper heating element embedded in the upper cell holder for heating the upper portion of each of the battery cells; and a lower heating element embedded in the lower cell holder for heating the lower portion of each of the battery cells.

In certain embodiments, a heated battery cell holder includes a battery monitoring circuit configured to selectively supply a current to the upper and lower cell holders.

In certain embodiments, the battery monitoring circuit prevents the battery cells from connecting to a charging source and energizes the heating elements of each of the upper and lower cell holders when the temperature of the battery cells falls below a preset temperature threshold.

In certain embodiments, the battery monitoring circuit permits charging of the battery cells and ceases energizing the heating elements of each of the upper and lower cell holders when the temperature of the battery is above a preset temperature threshold.

In certain embodiments, the cell holders include nichrome.

In certain embodiments, a heated battery cell holder further includes an isolation layer configured on the cell holders such that the isolation layer electrically isolates each of the cell holders from the battery cells.

In certain embodiments, the heating elements are 3D printed onto the respective isolation layers of the cell holders.

In certain embodiments, a heated battery cell holder includes a housing configured to encase the upper cell holders, lower cell holders, and the plurality of cells.

In certain embodiments, the cell holders dispose the plurality of battery cells away from walls of the housing.

In certain embodiments, the cell holders dispose each of the batteries of the plurality of battery cells in apertures spaced apart at even intervals.

In certain embodiments, the heating elements are disposed in a space between apertures on the cell holders such that a distance between the heating element and adjacent apertures is minimized.

In certain embodiments, a heated battery cell holder includes temperature sensors embedded in the upper and lower cell holders for monitoring the temperature of the plurality of battery cells.

In certain embodiments, a battery with an internal heating element includes: a plurality of battery cells; a cell holder configured to hold the battery cells, wherein the cell holder includes a plurality of heating elements embedded in the cell holder; and the cell holder includes a plurality of apertures, wherein each of the apertures in the plurality is configured to secure a battery cell of the plurality of battery cells.

In certain embodiments, a battery includes a battery monitor circuit configured to supply a current to the embedded heating element when a temperature of the plurality of the battery cells or the battery cell holder is below a predetermined temperature threshold.

In certain embodiments, the cell holder includes a thermally conductive layer enclosed by an electrically isolating layer.

In certain embodiments, the thermally conductive layer is 0.5 cm to 2 cm thick.

In certain embodiments, the electrically isolating layer is 1 mm to 5 mm thick.

In certain embodiments, the heating elements include a high-resistance material with a positive temperature coefficient such that as the heating elements increase in temperature, the resistance increases, thereby reducing further temperature increases.

In certain embodiments, the battery monitor circuit is interfaced to an aircraft bus via a relay configured to supply current to the plurality of heating elements when the temperature of the plurality of battery cells is below the predetermined temperature threshold.

In certain embodiments, a battery includes a second battery cell holder such that the battery includes an upper and a lower battery cell holder configured to space the battery cells apart at even intervals.

### BRIEF DESCRIPTION OF THE DRAWING FIGURES

Embodiments of the invention are described in detail below with reference to the attached drawing figures, wherein:

FIG. 1 illustrates an exploded view of a lithium-ion battery assembly;

FIG. 2 illustrates a heating element embedded in a cell conductor; and

FIG. 3 illustrates a heating element embedded in a cell holder.

The drawing figures do not limit the invention to the specific embodiments disclosed and described herein. The drawings are not necessarily to scale, emphasis instead being placed upon clearly illustrating the principles of the invention.

### DETAILED DESCRIPTION

The following detailed description references the accompanying drawings that illustrate specific embodiments in which the invention can be practiced. The embodiments are intended to describe aspects of the invention in sufficient detail to enable those skilled in the art to practice the invention. Other embodiments can be utilized, and changes can be made without departing from the scope of the invention. The following detailed description is, therefore, not to be taken in a limiting sense. The scope of the invention is defined only by the appended claims, along with the full scope of the equivalents to which such claims are entitled.

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the technology can include a variety of combinations and/or integrations of the embodiments described herein.

When lithium-ion batteries get too cold, typically below 0° C., they cannot be safely charged. Charging a battery at or below this temperature can cause lithium plating on the anode. The deposited lithium reacts quickly with the electrolyte leading to irreversible capacity loss. Lithium plating can lead to dendrites that place pressure on the membrane separating the anode and cathode creating the possibility of penetrating the separator and shorting the cell internally. When enough pressure is built up the membrane can fail causing the battery to fail. Some lithium-ion batteries contain liquid electrolyte. When the electrolyte freezes the electrons cannot move, which means the battery cannot be used. To avoid lithium plating, lithium-ion batteries are charged at a very low rate at low temperatures, which increases the time to be fully charged. Further, rechargeable batteries have poor charge acceptance and suffer from excessively long charge time, especially at subfreezing temperatures, due to sluggish electrochemical kinetics and transport processes occurring in the battery cell. This is of particular concern in the aviation industry where batteries are exposed to extreme temperature fluctuations from 120° F. on the tarmac to minus 40° F. in flight. Charging batteries at reasonable rates in cold weather is difficult to carry out or may invite a much-shortened battery life.

Various methods have been proposed for heating elements for batteries for charging at low temperatures. Rechargeable batteries, charging methods and systems for charging a battery under cold temperatures without causing battery degradation have been proposed. The system monitors the temperature of the battery cell holder and applies heat when the temperature falls below a predetermined temperature. These systems typically include an external heating source, which is mounted or otherwise fastened to a battery cell holder, which adds volume and weight to the overall battery system and uneven heating of the batteries.

Accordingly, there exists a need to safely charge a cold lithium-ion battery and reduce the charging time of said battery without negatively affecting the battery and without increasing the volume and weight of the battery cell holder.

In a first embodiment, an internally heated battery comprises resistive heating elements integrated into one or more cell holders configured to hold individual battery cells within a lithium-ion battery. The cell holders physically contact each battery cell and hold the batteries in place. Heat travels through the cell holders directly to the battery cells in contact with the cell holder.

In a second embodiment, an internally heated battery comprises resistive heating elements integrated into cell conductors such that the cell conductors may be used to conduct electricity or heat. The cell conductors provide an electrical interface for outputting voltage and current from the heated battery. Resistive heating elements are integrated into the cell conductors but also electrically isolated from the cell conductors. When the resistive heating elements are powered by a battery monitoring circuit, heat from the resistive heating elements travels through the cell conductors directly to the battery cells in contact with the cell conductors.

In an embodiment, the cell conductor with integrated resistive heating elements includes an electrically conductive tab interfaced to a battery terminal that may also be thermally conductive such that heat generated by an electrically isolated resistive heating element travels to the battery cell via conduction. The cell conductor is used to conduct electricity to the battery cells when the battery cells are charging/discharging, and sometimes the cell conductors are used to conduct heat to the battery cells for warming the battery cells.

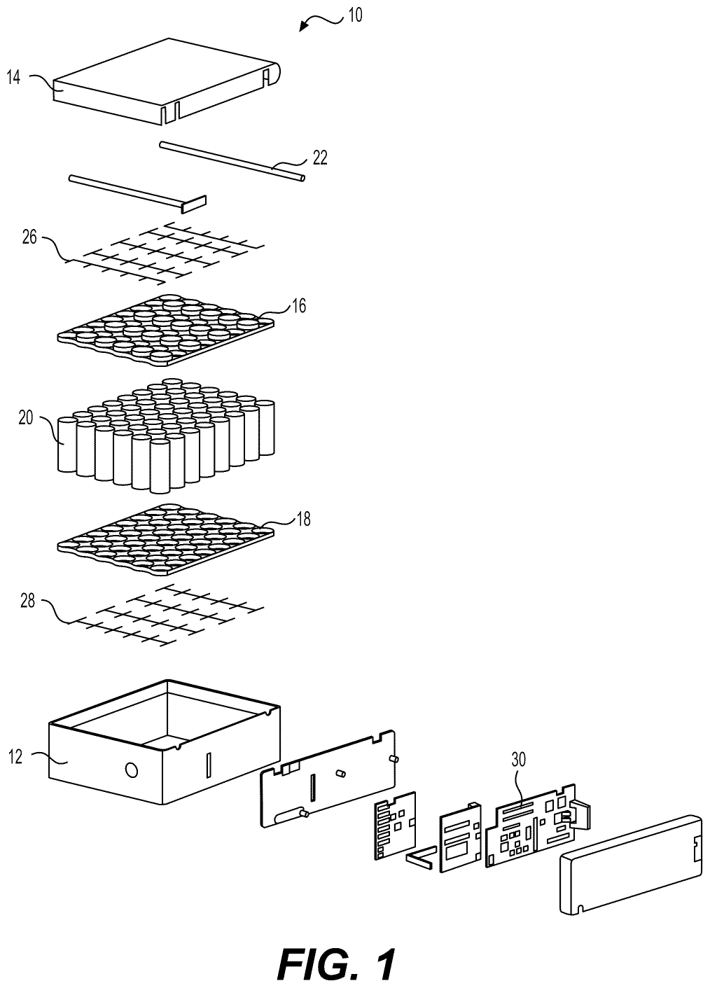

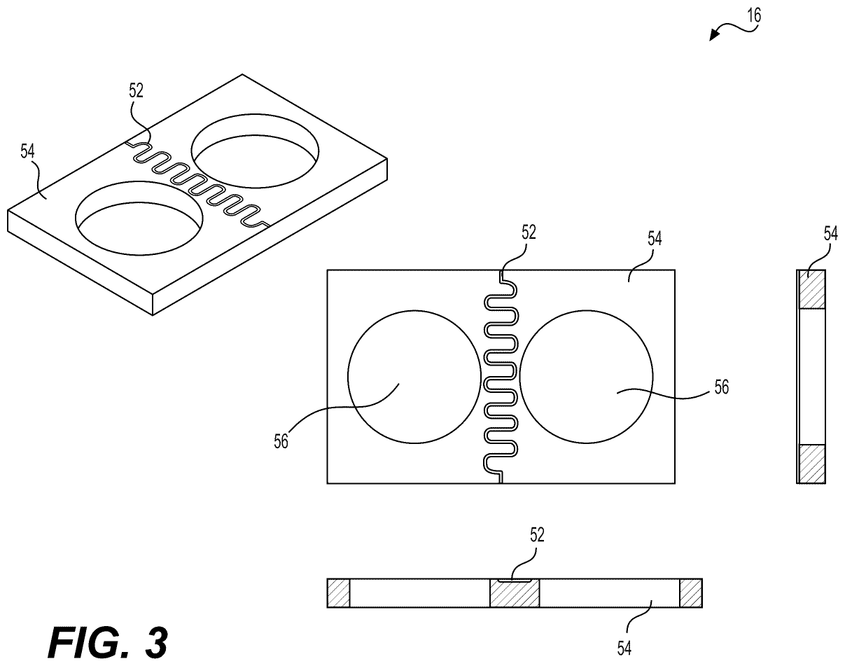

Referring to FIG. 1, a heated battery with an embedded heater configured on a cell conductor or on a cell holder is indicated by reference numeral 10. The heated battery 10 includes a housing 12 with a cover 14, an upper cell holder 16 and a lower cell holder 18, a plurality of battery cells 20, conduction rails 22, an upper 26 and lower 28 cell conductor, and a battery monitoring circuit 30. All of the components of the heated battery 10 are encased or mounted on or within the housing 12. The upper cell holder 16 and lower cell holder 18 dispose the battery cells 20 away from the walls of housing 12 to electrically isolate the battery cells. Additionally, insulation (not shown) may be used in embodiments to assist with heat retention in a heated battery 10. The holders also enclose or hold an upper and lower portion respectively of each battery cell of the battery cells 20. As seen in FIG. 3, the cell holders 16 and 18 include a matrix of evenly spaced apertures 56 for receiving and securing the plurality of battery cells 20 in a spaced-apart configuration. As illustrated in FIG. 1, the plurality of battery cells 20 includes 48 batteries arranged in eight rows of six batteries. This configuration of batteries is for illustration only and not a limitation, as any configuration and number of batteries may be included as a design requires.

The lower cell holder 18 receives the bottoms of the plurality of battery cells 20 and the upper cell holder 16 is placed over the tops of the plurality of battery cells 20 to secure the battery cells 20 within the housing 12. In embodiments, more or fewer cell holders may be used to secure the plurality of battery cells 20 in place. The conduction rails 22 provide electrical contact between the plurality of battery cells 20 as necessary for a desired output voltage from the plurality of battery cells 20. The conduction rails 22 are electrically coupled to the battery monitor circuit 30. The upper cell holder 16 and lower cell holder 18 include temperature sensors coupled to the battery monitor circuit and embedded in the holders 16 and 18 to monitor the temperature of the battery cells 20.

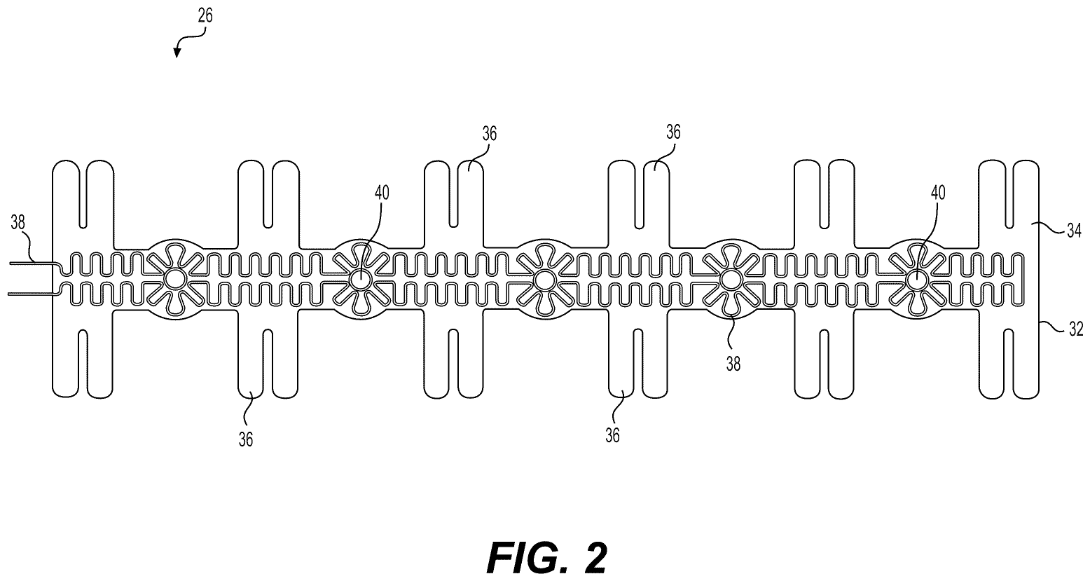

FIG. 2 depicts an embodiment upper electrical cell conductor 26 configured with one or more resistive heating elements 38. Referring to FIGS. 1 and 2, the upper 26 and lower 28 electrical cell conductors include a cell conductor substrate 32 and a thermally conductive but electrically isolated layer 34 on the cell conductor substrate 32. The cell conductor substrate 32 includes cell conductor tabs 36 extending from one or both sides of the cell conductor substrate 32 and a resistive heating element 38 coupled to the battery monitor circuit 30.

The upper 26 and lower 28 electrical cell conductors may comprise a linear configuration with cell conductor tabs 36 configured in pairs and spaced apart at even intervals along the length of the upper 26 and lower 28 electrical cell conductors. Each tab 36 extends outward from its electrical cell conductor, and two tabs in a pair may be disposed substantially close or adjacent to one another. Each tab 36 is electrically interfaced to a battery cell of the plurality of battery cells battery cells 20 such that electricity is conducted from tabs 36 to battery cells 20. Each tab 36 is a positive or negative terminal. Simultaneously, tabs 36 are thermally conductive such that heat may be transferred along the upper 26 and lower 28 electrical cell conductors to any batteries in physical contact with tabs 36.

A plurality of apertures 40 may be surrounded by resistive heating elements 38 such that the apertures 40 and thus the resistive heating elements 38 are spaced at even intervals along the length of the upper 26 and lower 28 electrical cell conductors. Apertures 40 in electrical cell conductors 26 and 28 may be used for aligning the electrical cell conductors 26 and 28 with the battery cells 20 by contacting the ends of battery cells 20. The electrically isolated layer 34 may be configured to surround resistive heating elements 38, or may be otherwise disposed on cell conductor substrate 32 to electrically isolate resistive heating elements 38 from cell conductor substrate 32. In embodiments, the isolated layer 34 comprises a channel (not shown) closely resembling the shape of resistive heating element 38 configured to contain the resistive heating element 38. The resistive heating element 38 may be embedded on the thermally conductive and electrically isolated layer 34. The cell conductor tabs 36 of the upper 26 and lower 28 electrical cell conductors are in contact with the tops and bottoms of the plurality of battery cells 20. In place of or in conjunction with an electrically isolated layer, wires supplying current to resistive heating elements 38 may be electrically isolated yet thermally conductive via a thin film, a wrap, or electrical insulation configured on the wires and on resistive heating elements 38. To embed resistive heating elements 38 into cell conductor substrate 32, electrically isolated layer 34 may be deposited on or pressed into cell conductor substrate 32 via 3D printing, injection molding, layering, or compression techniques.

The battery monitor circuit 30 monitors the temperature of the plurality of battery cells 20 and selectively supplies current to the plurality of battery cells 20 depending on said temperature. If the temperature of the battery cells 20 falls below a preset temperature threshold, such as 0° C., the battery monitor circuit 30 will prevent the battery cells 20 from connecting to a charging source (not shown). This prevents the battery cells 20 from becoming damaged by being charged when the temperature is too low. The battery monitor circuit 30 will energize resistive heating element 38 to provide heat directly to the battery cells 20 as conducted through the cell conductor tabs 36. Once the battery cells 20 reach a temperature greater than the preset temperature threshold that is safe for charging, the battery monitor circuit 30 will permit the battery cells 20 to be charged by the charging source, and cease energizing resistive heating element 38.

FIG. 3 shows side, top, and perspective views of an exemplary section of the battery cell holders 16 and 18 from FIG. 1. In the embodiment heating system shown in FIG. 3, heating elements are integrated directly into battery cell holder 16. Sections of battery cell holder 18 may be identical if not symmetric or mirror-symmetric to the exemplary section of battery cell holder 16 shown in FIG. 3. Between each pair of individual slots of cell holder 16, a heating element 52 may be secured to a surface 54 of the cell holder 16 with conductive adhesive or printed on the surface 54 of the cell holder 16. The heating element 52 may also be embedded within the cell holder 16. Other arrangements of the heating element 52 with respect to the individual slots of the cell holder 16 are possible without departing from the scope hereof.

The heating element 52 is coupled to a battery monitor circuit 30, which monitors the temperature of the plurality of battery cells 20. If the temperature of the battery cells 20 falls below a preset temperature threshold, such as 0° C., the battery monitor circuit 30 will prevent the battery cells 20 from connecting to a charging source (not shown). This prevents the battery cells 20 from becoming damaged by being charged when the temperature is too low. The battery monitor circuit 30 will energize the heating element 52 to provide heat directly to the battery cells 20 through the cell conductor tabs 36. Once the battery cells 20 reach a temperature greater than the present temperature threshold that is safe for charging, the battery monitor circuit 30 will allow the battery cells 20 to be charged by the charging source and will cease energizing the heating element 52.

The cell holders 16, 18 may be 3D printed using a thermally conductive material, which exhibits both electrical isolation and thermal conductivity. The electrical insulation property of the material may be measured as electrical resistivity and may be in the range of volume-resistivity >10¹³ ohm×m, for example. The thermally conductive layer may be 0.5 cm to 2 cm thick. An isolation layer may be printed on the surface of the cell holders 16, 18 to electrically isolate cell holders 16. 18 from the plurality of battery cells 20. The isolation layer may be 1 to 5 mm thick.

The heating elements 52 may be embedded on the isolation layer printed on the surface 54 of the cell holders 16 and 18, or may be embedded directly on the cell holders. The heating elements 38 may be embedded or disposed on the isolation layer 34 of the electrical cell conductors 26 and 28. The heating elements 38 and 52 may consist of a high-resistance material such that when a voltage is applied across it, the resulting current flow makes the material heat up. For example, nichrome wire (80% nichrome/20% chromium) is commonly used when making heating elements. Nichrome wire has a relatively high resistance and forms a chromium oxide layer on the outside after its first use, which prevents the element from deteriorating after further uses. Nichrome wire also has a positive temperature coefficient, which means that as it heats up, the resistance increases, which helps to prevent further heating. The thickness of the heating element may be 1 to 10 mm, for example. The heating elements 52 may be printed on another material and transferred to the cell holders 16 and 18, and secured using a thermally conductive epoxy or other adhesive.

Advantages of the invention include that it eliminates the need for a separate heater element, it provides optimal thermal coupling to the internal battery cells 20, it provides high energy transfer efficiency (i.e., a large heat output for a relatively small electrical input), and it integrates the heating element into the cell holder thereby minimizing physical space needed.

An internally heated battery of the illustrated embodiments may be employed on an aircraft to mitigate the issues presented by cold temperatures encountered during takeoff or during flight, such as at high altitudes. As cold batteries must be warmed for safe operation, the battery monitor circuit 30 may be electrically interfaced via a relay to an aircraft bus with an external power supply, such as power generated by an aircraft engine (propeller, thruster, etc.).

Although the invention has been described with reference to the embodiments illustrated in the attached drawing figures, it is noted that equivalents may be employed and substitutions made herein without departing from the scope of the invention as recited in the claims.

Having thus described various embodiments of the invention, what is claimed as new and desired to be protected by Letters Patent includes the following:

1. A heated battery cell holder comprising:
an upper cell holder having a plurality of holders each configured for securing an upper portion of one of a plurality of battery cells, respectively;
a lower cell holder having a plurality of holders each configured for securing a lower portion of one of the battery cells, respectively;
an upper heating element embedded in the upper cell holder for heating the upper portion of each of the battery cells; and
a lower heating element embedded in the lower cell holder for heating the lower portion of each of the battery cells.

2. The heated battery cell holder of claim 1, comprising a battery monitoring circuit configured to selectively supply a current to the upper and lower cell holders.

3. The heated battery cell holder of claim 2, wherein the battery monitoring circuit prevents the battery cells from connecting to a charging source and energizes the heating elements of each of the upper and lower cell holders when the temperature of the battery cells falls below a preset temperature threshold.

4. The heated battery cell holder of claim 2, wherein the battery monitoring circuit permits charging of the battery cells and ceases energizing the heating elements of each of the upper and lower cell holders when the temperature of the battery is above a preset temperature threshold.

5. The heated battery cell holder of claim 1, wherein the cell holders comprise nichrome.

6. The heated battery cell holder of claim 5, further comprising an isolation layer configured on the cell holders such that the isolation layer electrically isolates each of the cell holders from the battery cells.

7. The heated battery cell holder of claim 6, wherein the heating elements are 3D printed onto the respective isolation layers of the cell holders.

8. The heated battery cell holder of claim 1, comprising a housing configured to encase the upper cell holders, lower cell holders, and the plurality of cells.

9. The heated battery cell holder of claim 8, wherein the cell holders dispose the plurality of battery cells away from walls of the housing.

10. The heated battery cell holder of claim 9, wherein the cell holders dispose each of the batteries of the plurality of battery cells in apertures spaced apart at even intervals.

11. The heated battery cell holder of claim 10, wherein the heating elements are disposed in a space between apertures on the cell holders such that a distance between the heating element and adjacent apertures is minimized.

12. The heated battery cell holder of claim 1, comprising temperature sensors embedded in the upper and lower cell holders for monitoring the temperature of the plurality of battery cells.

13. A battery with an internal heating element, comprising:
a plurality of battery cells; and
a cell holder configured to hold the battery cells,
wherein the cell holder comprises a plurality of heating elements embedded in the cell holder; and
the cell holder comprises a plurality of apertures, wherein each of the apertures in the plurality is configured to secure a battery cell of the plurality of battery cells.

14. The battery of claim 13, comprising a battery monitor circuit configured to supply a current to the embedded heating element when a temperature of the plurality of the battery cells or the battery cell holder is below a predetermined temperature threshold.

15. The battery of claim 13, wherein the cell holder comprises a thermally conductive layer enclosed by an electrically isolating layer.

16. The battery of claim 15, wherein the thermally conductive layer is 0.5 cm to 2 cm thick.

17. The battery of claim 15, wherein the electrically isolating layer is 1 mm to 5 mm thick.

18. The battery of claim 13, wherein the heating elements comprise a high-resistance material with a positive temperature coefficient such that as the heating elements increase in temperature, the resistance increases, thereby reducing further temperature increases.

19. The battery of claim 14, wherein the battery monitor circuit is interfaced to an aircraft bus via a relay configured to supply current to the plurality of heating elements when the temperature of the plurality of battery cells is below the predetermined temperature threshold.

20. The battery of claim 13, comprising a second battery cell holder such that the battery comprises an upper and a lower battery cell holder configured to space the battery cells apart at even intervals.
